(19) United States
(12) Patent Application Publication
(10) Pub. No.: US 2015/0288194 A1
(43) Pub. Date: Oct. 8, 2015

(54) INDUCTIVE DEVICE LIMITING ACOUSTIC OSCILLATIONS

(71) Applicant: RENAULT s.a.s., Boulogne-Billancourt (FR)

(72) Inventors: Louis-Marie Genet, Sotteville Les Rouen (FR); Laurent Desreumaux, Conflans Saint Honorine (FR)

(73) Assignee: RENAULT s.a.s., Boulogne-Billancourt (FR)

(21) Appl. No.: 14/427,402

(22) PCT Filed: Sep. 24, 2013
(86) PCT No.: PCT/FR13/52221

§ 371 Date: Mar. 11, 2015

(30) Foreign Application Priority Data
Sep. 27, 2012 (FR) 1259093

(51) Int. Cl. H02J 5/00

(52) U.S. Cl. CPC H02J 5/005

(57) ABSTRACT

An inductive device including a winding in which a ferromagnetic body including gaps is inserted, the winding being held in a metal casing, and in which a thermally conductive film is placed between the ferromagnetic body and a base of the metal casing, the film having a stiffness lower than that of a synthetic resin

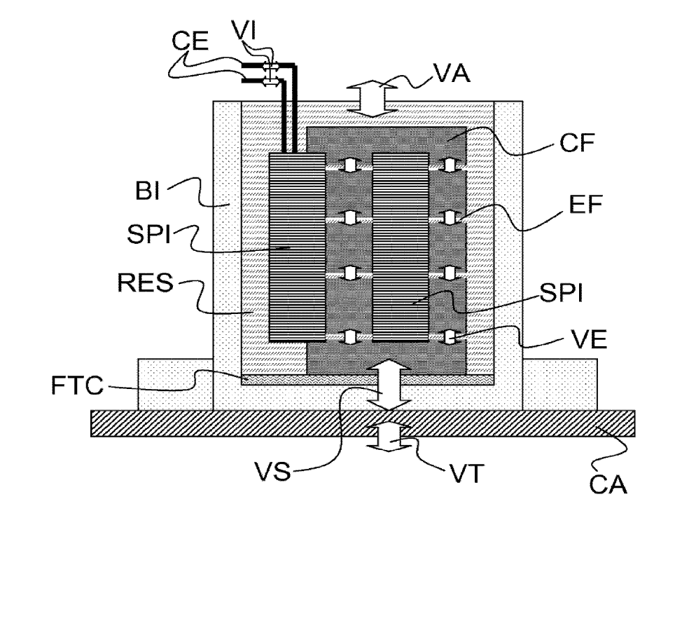

The present invention relates in a general way to the field of electrical engineering, and more precisely to an inductive device for power electronics, that is to say a device that can withstand, for example, a current of about a hundred amperes, and which can be used, notably, in chargers for electric or hybrid vehicles.

An inductive device or inductance of this type includes, in a known manner, a winding through the inside of which passes a ferromagnetic body, having gaps which are mechanical interstices intended to limit the saturation of the ferromagnetic body. This body is, for example, formed by a plurality of ferromagnetic blocks, for example ferrite blocks, separated from one another by the gaps. The winding and the ferromagnetic body are both inserted into an aluminum pot and embedded in resin. The ferromagnetic body is placed directly in contact with the base of the pot in order to facilitate its cooling.

When variations of current flow through the winding, due for example to current switching upstream of the inductive device, corresponding variations of attraction and/or repulsion between the ferromagnetic blocks cause deformations in the ferromagnetic body, resulting in vibrations in the gaps, which are filled with air or resin. These vibrations are generated at a frequency identical to that of the electrical excitation of the winding, and are transmitted to the aluminum pot forming the housing of the inductive device. Since this housing is generally fixed integrally to a casing, for example a power electronics casing, the vibrations are also transmitted to the casing. Given the weight of the inductive device, the device thus radiates an acoustic power, which causes problems such as noise or mechanical embrittlement of the inductive device and of the underlying power electronics, the more so if it is propagated through the system and added to the vibrations of a casing cooling system. Since the casing may be less structural in mechanical terms than the inductive device, it amplifies the acoustic pollution that is generated.

To reduce the vibrations of an inductive device of this type, there is a known way of using ferromagnetic bodies with structures different from ferromagnetic blocks separated by gaps. For example, it is possible to use a ferromagnetic body made of stacked and inverted plates, or a molded ferromagnetic body with a gap distributed through the ferromagnetic body in the form of air bubbles.

However, these solutions are costly and are incompatible with the design requirements of a low-cost hybrid or electric vehicle.

One object of the invention is to overcome at least some of the drawbacks of the prior art by providing an inductive device which limits the vibrations transmitted to the outside of the device when a variable current passes through it, in an economical and effective way. Notably, the invention enables these vibrations to be limited without the need to limit the variations in current flowing through the device, which would mean losing the benefit of the maximum electrical power that can be used with the inductive power device.

To this end, the invention proposes an inductive device including a winding in which a ferromagnetic body having gaps is at least partially inserted, said winding being held in a metal housing of said device, characterized in that a thermally conductive film is placed between said ferromagnetic body and one of the bases of said metal housing, said film having a stiffness lower than that of a synthetic resin, such as for example the resin that fills the metal housing containing the winding and the ferromagnetic body.

Preferably, the thermally conductive film is arranged in the same direction as the gaps, or as most of the gaps.

The invention makes it possible to use an inexpensive ferromagnetic body in the inductive device according to the invention, the vibrations being decreased by means of the thermally conductive film. This is because this arrangement provides greater mechanical decoupling between the ferromagnetic body and the housing of the device than that provided by a resin for holding the ferromagnetic body and the winding in the housing of an inductive device. Furthermore, the use of a thermally conductive film makes it possible to continue to cool the ferromagnetic body by means of a casing which is itself cooled and to which the base of the housing of the inductive device according to the invention is fixed. It also makes it possible to retain the structural stiffness of the elements of the inductive device and of the interface between the latter and the casing. Finally, it avoids the use of more structural ferromagnetic bodies, such as molded bodies with distributed gaps and bodies made of assembled plates. These solutions are more costly in terms of both materials and manufacture. Furthermore, solutions using molded ferromagnetic bodies are less satisfactory in terms of magnetic performance than assembled ferrite bodies.

According to an advantageous characteristic of the invention, said base of the metal housing is fixed integrally to a metal casing of at least one power electronics module of a vehicle having an electric propulsion motor.

By fixing the inductance device according to the invention to a power electronics casing of an electric or hybrid vehicle, used for example for the electrical recharging of such a vehicle, it is possible to optimize the overall dimensions of the vehicle charger and to reduce its cost, since the inductive device is itself a component of the charger. In fact, an inductive device of this type is inexpensive, and its positioning is not constrained even within the power electronics casing.

According to another advantageous characteristic, said base of said housing is positioned on an area of said casing subject to the action of a cooling system.

Thus the cooling system used for cooling a power electronics module of a charger of an electric or hybrid vehicle, for example, is also used to cool the inductive device.

According to another advantageous characteristic, said winding and said ferromagnetic body are structurally held in said housing by a damping synthetic resin, whose isostatic compression stiffness is below 500 MPa.

Preferably, the stiffness of this damping resin provided by the isostatic compression modulus is in the range from 100 MPa to 1000 MPa (megapascal).

By using this damping synthetic resin to hold the winding and the ferromagnetic body of the inductive device in the housing, it is possible to damp the “airborne” vibrations of the inductive device, thereby reducing the overall acoustic power radiated by the inductive device. In fact, at the base of the housing, the resin is not present, or is only present in a small amount, and the vibration damping is provided by the thermally conductive film, allowing the housing to be mechanically decoupled from the casing. This resin is therefore present between the housing, on the one hand, and the winding and the ferromagnetic body, on the other hand, in the part where the housing is externally in contact with free air.

According to another advantageous characteristic, said thermally conductive film has an isostatic compression stiffness of less than 10 MPa.

Thus the conductive film is flexible enough for the mechanical decoupling between the housing of the inductive device and the casing to reduce the acoustic vibrations at the base of the housing by approximately ten decibels at least, for an inductive device through which currents in the range from 10 to 250 amperes flow (in the various possible modes of use of the product).

According to another advantageous characteristic, said thermally conductive film has a thermal conductivity of more than 0.5 W/mK.

This characteristic enables the inductive device to be cooled easily by the casing, in spite of the presence of the film.

According to another advantageous characteristic, said thermally conductive film has a thickness in the range from 0.1 to 2 mm.

This low thickness of the film enables a good level of thermal conductivity to be maintained at the base of the housing, while good acoustic isolation of the inductive device is provided.

Other characteristics and advantages will be evident from a reading of a preferred embodiment described with reference to the single figure representing an inductive device according to the invention, in this preferred embodiment.

According to a preferred embodiment of the invention shown in the figure, the inductive device according to the invention has a housing BI formed by an aluminum pot. The housing BI is fixed by four screws at its lower base to a casing CA protecting power electronics modules of an electric vehicle charger, in an area of the casing CA cooled by a cooling system of the charger. This is because the inductive device is used, in this embodiment of the invention, as an inductance of an electric vehicle charger.

A winding SPI is held vertically in the longitudinal direction in the housing BI, and is connected to electrical connectors CE, through which a high current having current variations VI enters and leaves when the inductive device is in use. A ferromagnetic body CF is partially inserted into the winding SPI. It is composed of ferromagnetic blocks, for example ferrite blocks, spaced apart by gaps EF placed transversely with respect to the winding SPI.

The ferromagnetic body is placed on a thermally conductive film FTC covering the inner surface of the lower base of the housing BI. The winding SPI and the ferromagnetic body CF have been embedded in a resin RES present on their periphery and in the upper part of the housing BI. The resin RES enables the winding SPI and the ferromagnetic body CF to be held structurally within the housing BI, and has been poured on top of the thermally conductive film FTC.

The thermally conductive film FTC has a filtering and damping function, making it possible to reduce the vibrations emitted by the ferromagnetic body CF when the inductance device is subjected to current variations VI. In fact, these current variations VI cause vibrations VE at the gaps EF, which are manifested as airborne vibrations VA where the housing is in contact with free air, and structure-borne vibrations VS at the lower base of the housing BI fixed to the casing CA. The thermally conductive film FTC makes it possible to reduce the structure-borne vibrations VS and the airborne vibrations VA by about ten decibels for currents of the order of 250 amperes flowing through the inductive device, and, by this decoupling, to reduce the vibrations VT transmitted to the casing CA. It should be noted that the decoupling between the ferromagnetic body CF and the base of the housing BI also makes it possible to limit the movement of the ferromagnetic body CF, because of the reduced feedback between the ferromagnetic body CF and the base of the housing BI. In this way the vibrations of the ferromagnetic body CF transmitted by the airborne route are therefore reduced.

In order to achieve a good level of filtering and damping, while maintaining good thermal conductivity for cooling the inductive device by means of the casing CA, the thermally conductive film FTC typically has the following properties:
its thickness is in the range from 0.1 mm (millimeters) to 2 mm,
its thermal conductivity is greater than 0.5 W/mK (watts per meter kelvin),
and its stiffness, given by its isostatic compression modulus, is less than 10 MPa (megapascal), and at least less than 50 times the isostatic compression modulus of the resin RES. It should be noted that the film FTC is installed with a compression rate that prevents its mechanical crushing, ideally with a compression rate in the range from 90% to 30% of its initial thickness in the compressed areas.

The choice of the thickness and material of the thermally conductive film FTC depends on a compromise. This is because:
as the thickness of the thermally conductive film FTC increases, the acoustic isolation of the inductive device improves, but it also becomes more isolated thermally, and the inductive device becomes more costly;
as the stiffness of the thermally conductive film FTC decreases, that is to say as it becomes more flexible, the acoustic isolation of the inductive device is increased, but the film FTC becomes less thermally conductive;
as the thermal conductivity of the film FTC increases, the film becomes more costly.

Preferably a thermally conductive film FTC of a type such as that marketed under the name of Keratherm® Softtherm® 86/320, with a thermal conductivity of 2.5 W/mK, a thickness of 1 mm and a stiffness of 3.2 MPa, is used for the application of the invention.

Similarly, a damping synthetic resin with an isostatic compression modulus of less than 500 MPa and a thermal conductivity in the range from 0.05 W/mK to 2 W/mK is preferably used as the resin RES, an example being the resin marketed under the trade name ELAN_TRON® MC125W80LV.

For a current of 210 amperes flowing through the inductive device, the use of a damping resin RES in addition to the film FTC enables the acoustic level of the radiation of the inductive device to be reduced by fifteen decibels.

Evidently, other embodiments of the invention are possible. For example, in another embodiment of the invention, the housing is held horizontally by being fixed to a casing located under the housing or laterally with respect to the housing, according to the architecture used for the vehicle charger, at the cost of increased structure-borne propagation. It should be noted that a possible alternative is, for example, that of providing decoupling around the fixing points, using solutions of the “silent block” type, with the addition of a thermal interface sheet in the area of heat exchange between the casing and the inductance device, to provide continuity of heat dissipation. Finally, the invention is, evidently, usable for applications other than those in the motor vehicle field, and at higher current levels, with a redesign of the decoupling.

1-6. (canceled)

7. An inductive device comprising:
a winding in which a ferromagnetic body including gaps is at least partially inserted, the winding being held in a metal housing of the device; and
a thermally conductive film placed between the ferromagnetic body and one of bases of the metal housing, the film having an isostatic compression stiffness of less than 10 MPa.

8. The inductive device as claimed in claim 7, wherein the base of the metal housing is fixed integrally to a metal casing of at least one power electronics module of a vehicle having an electric propulsion motor.

9. The inductive device as claimed in claim 7, wherein the base of the housing is positioned on an area of the casing subject to action of a cooling system.

10. The inductive device as claimed in claim 7, wherein the winding and the ferromagnetic body are structurally held in the housing by a damping synthetic resin, whose isostatic compression stiffness is below 500 MPa.

11. The inductive device as claimed in claim 7, wherein the thermally conductive film has a thermal conductivity of more than 0.5 W/mK.

12. The inductive device as claimed in claim 7, wherein the thermally conductive film has a thickness in a range of 0.1 to 2 mm.
